(19) United States
(12) Patent Application Publication
(10) Pub. No.: US 2016/0273263 A1
(43) Pub. Date: Sep. 22, 2016

(54) FRAME ASSEMBLY FOR RETAINING A SCREEN

(71) Applicant: CAPRAL LIMITED, Parramatta CBD BC, NSW (AU)

(72) Inventors: Enrico Farina, Wollongong, New South Wales (AU); Antonio Farina, Wollongong, New South Wales (AU); Jeffrey Frederick Rotin, Tullamarine, Victoria (AU)

(21) Appl. No.: 15/036,744

(22) PCT Filed: Dec. 5, 2014
(86) PCT No.: PCT/AU2014/001109

§ 371 Date: May 13, 2016

(30) Foreign Application Priority Data
Dec. 6, 2013 (AU) 2013904761
May 13, 2014 (AU) 2014901763

(51) Int. Cl. E06B 3/58; E06B 3/16; E06B 9/24; E06B 3/06; E06B 9/02; E06B 9/52

(52) U.S. Cl. CPC E06B 3/58; E06B 9/02; E06B 9/52; E06B 9/24; E06B 3/06; E06B 3/16; B23P 2700/08; E06B 2009/527

(57) ABSTRACT

A frame assembly for retaining a screen, comprising a frame portion with an attachment channel for receiving an edge of a screen infill, the attachment channel having a first surface and the frame portion including an engagement portion against which a first part of a locking insert is held, wherein the locking insert has a second part for bearing towards a screen infill inserted in the attachment channel, the locking insert being resilient so that when the locking insert is positioned with the first part held by the engagement portion the second part applies a force to urge the screen infill against the first surface: and a friction interface provided either between the screen infill and the first surface and/or between the screen infill and the locking insert.

### FIELD OF THE INVENTION

The present invention relates to a frame assembly for retaining a screen. Examples of screens that can be retained by the frame assembly include security screens, such as used on security doors or windows, barriers such as fencing, partitions and other similar sheets broadly acting as screens. The present invention also relates to a locking insert for use in a frame assembly for retaining a sheet.

### BACKGROUND OF THE INVENTION

Security doors are typically secondary doors mounted to a doorway externally of the main door. Security doors typically comprise a metal perimeter frame with an infill material extending within and across the perimeter frame. The infill material comprises one or more of a mesh screen, a pattern metal structure or a perforated metal sheet. The security door provides a second layer of protection for the occupants. It also allows the main door to be kept open whilst maintaining security to provide visibility and improved airflow in the dwelling.

A problem with current security door assemblies is that the infill material needs to be attached to the perimeter frame by mechanical fasteners such as rivets and cover trims, which increases manufacturing costs and time requirements. An alternative to mechanical fasteners is to assemble the infill material under high forces to overcome the force fit required by the assembly to hold the infill material in place. Such forces can be applied using pneumatic or hydraulic equipment or using significant hitting forces to assemble the frame assembly with the infill material.

The present invention seeks to overcome or substantially ameliorate at least some of the deficiencies of the prior art, or to at least provide an alternative.

It is to be understood that, if any prior art information is referred to herein, such reference does not constitute an admission that the information forms part of the common general knowledge in the art, in Australia or any other country.

### SUMMARY OF THE INVENTION

In accordance with the invention there is provided a frame assembly for retaining a screen, comprising: a frame portion with an attachment channel for receiving an edge of a screen infill, the attachment channel having a first surface and the frame portion including an engagement portion against which a first part of a locking insert is held, wherein the locking insert has a second part for bearing towards a screen infill inserted in the attachment channel, the locking insert being resilient so that when the locking insert is positioned with the first part held by the engagement portion the second part applies a force to urge the screen infill against the first surface; and a friction interface provided either between the screen infill and the first surface and/or between the screen infill and the locking insert.

It is understood that the term “screen” and “screen infill” is used herein in a broad sense to mean any kind of planar material that may require retaining along one edge. Examples of screens falling within the scope of the use of the invention include metal screens whether mesh or perforated or solid, such as aluminium, alloy or steel; security and non-security (eg. insect) screens; non-metal screens including plastics, fibre reinforced sheet, cement sheet, woven fibreglass, carbon fibre (eg. Kevlar®)—whether used as access screens, partitions, sheets, fencing, permanent or non-permanent structures; glass panels for use as partitions, eg. in pool fencing or balustrades or facades; internal or external partitions made of timber, plastics, and composites or any of the above described materials.

In one embodiment the attachment channel has a second surface spaced from the first surface and the second surface defines the engagement portion against which the locking insert is held. Accordingly, in this embodiment the locking insert is inserted into the attachment channel.

In an alternate embodiment the attachment channel is defined by the first surface and a second surface spaced from the first surface, and the engagement portion against which the locking insert is held is provided outside the attachment channel. Accordingly, the frame portion provides a second channel separate from, but adjacent to, the attachment channel and the locking insert is inserted into the second channel. To urge against the screen infill the locking insert in this embodiment extends into the attachment channel and over a low web defining the second surface of the attachment channel.

In alternate embodiments, either the second surface comprises a locking profile for engaging the locking insert or the engagement portion comprises a locking profile for engaging the locking insert. The locking insert comprises an engagement formation for engaging the locking profile on either the second surface or the engagement portion in the separate channel.

The friction interface preferably comprises an adhesive, such as double sided adhesive tape, or glue. Alternatively, the friction interface could be a member having a high friction surface, such as rubber. The friction interface could be carried on a friction member adapted to be held against the screen infill by an interlocking engagement with the first face. For example, the friction member could be a rigid polyvinyl chloride (PVC) insert that is retained against the first surface by an interlocking engagement profile, or similar, and which PVC insert could be applied with adhesive tape to lie against the screen infill to resist withdrawal of the infill when deflected under load (eg. a force on the security screen).

A non-conductive isolator may be provided in some embodiments in the attachment channel. The isolator is adapted to locate between the screen infill and frame portion to avoid corrosion between dissimilar materials.

In accordance with the invention there is further provided a locking insert for inserting into a frame portion of a frame assembly for retaining a screen, the locking insert having a first part for engaging against an engagement portion of the frame portion, and a second part for bearing towards a screen infill, wherein the locking insert is resilient so that when the locking insert is positioned with the first part held by the engagement portion the second part applies a force to secure the screen infill in an attachment channel of the frame portion.

The force applied by the locking insert may be less than expected for a security screen having the strength to withstand significant impact. Additionally or alternatively, the force required to insert the locking insert into the frame portion is less than expected for a locking insert that can also apply sufficient force against the screen infill to secure it in the frame portion. A relatively low insertion force means that it is easier and faster to assemble the security screen using the frame assembly because there are no great forces required to be overcome in wedging the locking insert into the frame portion. Rather, the locking insert can be inserted manually without tools and by hand, or alternatively with a simple mallet and block. In one assessment, the force required to insert the locking insert into the frame portion is less than 2500 N per lineal metre and more preferably around 1000 N per lineal metre.

The locking insert is elongate and shaped in cross-section to substantially comprise a “C” shape having an end portion and arms extending substantially perpendicularly from the end portion. One or more of the arms may comprise an engagement formation for engaging the engagement portion of the frame portion.

The locking insert may comprise a pressure surface against which pressure can be applied during assembly to insert the locking insert into a frame portion. The pressure surface may be substantially planar and is sufficiently wide to provide a gripping or handling surface for manual insertion into the frame portion.

The locking insert may be made of a metallic material, such as steel, or may be made of a non-metallic and non-conductive material where corrosion of the screen is an issue (eg. where the screen is of a metal other than aluminium). Such a non-conductive material could be a plastics material, eg. polyvinyl chloride (PVC), a carbon-based material, eg. graphite, or known non-conductive composite materials.

In accordance with the invention there is still further provided a method of assembling a screen infill in a frame assembly, including:
applying a friction interface on one side of an edge of a screen infill;
inserting the edge of the screen infill into an attachment channel in a frame portion of the frame assembly;
inserting a locking insert into the frame portion and positioning the locking insert between the screen infill edge and an engagement portion of the frame portion, wherein the locking insert is resilient so that the locking insert applies a securing force toward the screen thereby clamping the screen and friction interface between the locking insert and a surface of the attachment channel.

To ensure a more secure assembly, adhesive tape may be applied to both sides of the screen infill edge.

In accordance with the present invention there is still further provided a security screen comprising a frame assembly as described above, and a screen infill secured in the frame assembly.

The screen infill may be a perforated sheet or a woven mesh screen. The screen infill could be an aluminium infill, a stainless steel infill or a galvanised steel infill.

Also described herein is a frame assembly comprising:
a frame portion having spaced first and second surfaces defining an attachment channel;
an element having an edge portion for insertion into the attachment channel;
a compressible member to be disposed between the edge portion and the first surface; and
a locking insert to be disposed between the edge portion and the second surface.

In the above embodiment, the element may be an infill material and may be substantially planar.

In one embodiment, the compressible member is adhesive tape. The compressible member may be a two-sided adhesive tape for attachment to both the edge portion and the first surface.

In one embodiment, the locking insert when inserted into the attachment channel urges the edge portion towards the first surface.

The first and second surfaces may be defined by first and second webs of the frame portion, where the first and second webs extend longitudinally along the entire internal length of the frame portion.

In one embodiment described herein, the first surface is a flat surface.

The first surface may define a first engagement surface, and more specifically the first engagement surface is a serrated surface having a number of spaced teeth formations. The frame portion may comprise a locating protrusion between the first and second surfaces.

In one embodiment, the locking insert comprises a first side with engagement formations for engaging the edge portion. A second side of the locking insert comprises engagement formations for engaging the second surface. Engagement of the second side and the second surface may define locking means therebetween.

In one embodiment, the locking insert comprises an inner end portion with a locating groove disposed and shaped to receive the locating protrusion. It is understood that the locating engagement between the locking insert and the frame portion can be reversed in that the locking insert may have a locating protrusion and the frame portion a groove.

The second side comprises at least one arm with a tooth formation.

In one embodiment, the locking insert in cross-section comprises a first side with engagement formations for engaging the edge portion, an inner end portion and an outer end portion which extend perpendicularly from the first side, and first and second arms which respectively extend from the inner end portion and the outer end portion, wherein the first and second arms comprise engagement formations for engaging the first surface.

In one embodiment, the inner end portion comprises a locating groove disposed and shaped to receive a locating protrusion of the frame portion.

The infill material may be a planar sheet of any of the materials mentioned earlier, and is a preferred embodiment where the frame assembly is for forming a security screen, the screen can be a perforated aluminium sheet, stainless steel sheet, zinc/aluminium alloy coated steel sheet, galvanised steel sheet or other corrosion resistant coated steel sheet. In other embodiments the planar infill material could be made of woven fibreglass, carbon fibre, Kevlar®, or the like.

In one embodiment, the locking insert is dimensioned for urging the edge portion towards the first surface. In this embodiment, the locking insert provides a pressure of at least 10 psi and preferably at least 15 psi against the edge portion in use. Alternatively or additionally, the locking insert applies a pressure of less than 75 psi against the infill material, and preferably less than 50 psi.

In one embodiment, the engagement between the second side and the second surface provides a one-way insertion of the locking insert into the channel.

Also described herein is a security door assembly comprising:
a perimeter frame comprising frame portions, each frame portion having spaced first and second surfaces defining an attachment channel;
an infill material having edge portions for respective insertion into the attachment channel of each frame portion;
a respective compressible member to be disposed between each edge portion and the first surface of each frame portion; and
a respective locking insert to be disposed between each edge portion and the second surface of each frame portion.

In one embodiment, the frame portions are cut at their ends for respectively engaging and forming corners of the perimeter frame.

In one embodiment, each locking insert comprises a first side with engagement formations for engaging the edge portion.

In one embodiment, each locking insert comprises a second side with engagement formations for engaging the second surface.

In one embodiment, the engagement between the second side and the second surface provides a one-way insertion of each locking insert into the respective channel.

Further described herein is a frame assembly comprising:
a frame portion having spaced first and second surfaces defining an attachment channel, the second surface defining a first engagement means and the first surface defining an attachment surface; and
a locking insert to be disposed within the attachment channel, the locking insert comprising a corresponding second engagement means for engaging the first engagement means.

Preferably, the first engagement means is a serrated surface and the second engagement means comprises teeth.

Preferably, the locking insert comprises a side with engagement formations for engaging an element to be inserted into the attachment channel.

Preferably, the locking insert in cross-section comprises a first side with the engagement formations, an inner end portion and an outer end portion which extend perpendicularly from the first side, and first and second arms which respectively extend from the inner end portion and the outer end portion, wherein the first and second arms comprise the second engagement means for engaging the first engagement means.

Preferably, the frame portion and the locking insert comprises pin apertures, the assembly further comprising a locking pin insertable through aligned pin apertures to extend outwardly of the frame portion.

Preferably, the assembly further comprises biasing means for biasing of the locking pin towards its extended locking position, resisting means for resisting removal of the locking pin, and/or locking the locking pin in its extended locking position.

Still further described herein is a frame assembly comprising:
a frame portion having an attachment web defining a first attachment surface, the frame portion defining a first attachment means;
a locking insert having a corresponding second attachment means for connection to the first attachment means, the locking insert comprising a second attachment surface; wherein the first and second attachment surfaces form an attachment channel when the first and second attachment means are connected to each other.

Preferably, the first attachment means is a channel formed by the attachment web.

Preferably, the channel comprises serrated connection formations at opposing surfaces thereof and the second attachment means comprises corresponding formations in the locking insert.

Also described herein is a frame assembly comprising:
a frame portion having spaced first and second webs defining an attachment channel therebetween, the attachment channel defining an entry glue receiving chamber and an internal glue receiving chamber; and
wherein the channel is adapted to receive attachment glue in the entry glue receiving chamber and an edge portion of an element, the element moving at least some of the attachment glue to the internal glue receiving chamber upon insertion.

### BRIEF DESCRIPTION OF THE DRAWINGS

Notwithstanding any other forms which may fall within the scope of the present invention, preferred embodiments of the present invention will now be described, by way of examples only, with reference to the accompanying drawings in which:

FIG. 1(a) is a cross-section view of a side portion of a frame assembly for a security screen in accordance with a first preferred embodiment of the present invention;

FIG. 1(b) is an enlarged view of the side portion of FIG. 1(a);

FIGS. 2(a) to 2(d) are a series of drawings illustrating the steps is assembling a security screen using the frame assembly of the first embodiment;

FIGS. 3(a) to 8 show further representations in the assembly of a door using the frame assembly of the first embodiment;

FIG. 9 is a cross-section view of a side portion of a frame assembly for a security door in accordance with an embodiment described herein;

FIG. 10 is a cross-section view of a side portion of a frame assembly for a security door in accordance with another embodiment described herein;

FIG. 11 is a cross-section view of a side portion of a frame assembly in accordance with second embodiment of the present invention, the assembly being similar to that shown in FIG. 1 and being adapted for use as a window security screen;

FIG. 12a schematically shows installation of a window screen in one embodiment being hinged at one side edge and having the securement pins at the opposing side edge, and 12b schematically shows installation of the window screen and another embodiment having securement pins at both opposing side edges;

FIG. 13 shows a modification of the embodiment of the FIG. 11 comprising biasing means for the securement pins;

FIGS. 14 to 16 show modifications of the biasing means for the securement pins;

FIGS. 17(a) to 17(e) illustrate various optional embodiments of the frame assembly for securing an infill screen made of the same metal as a frame portion of the frame assembly;

FIGS. 18(a) to 18(c) illustrate various optional embodiments of the frame assembly for securing an infill screen made of dissimilar material as a frame portion of the frame assembly; and

FIGS. 19(a), 19(b) and 19(c) illustrate three stages of insertion of the locking insert at which insertion forces were measured in a test discussed in Example 1.

### DESCRIPTION OF EMBODIMENTS

It should be noted in the following description that like or the same reference numerals in different embodiments denote the same or similar features.

In the broadest sense, the frame assemblies and locking inserts described herein can be used for retaining screens, in the form of a planar member, for a number of different uses including as access screens, dividers/partitions, fencing/balustrades, in a range of different applications. Accordingly, the infill material, ie. the screen, can comprise a range of different materials including metal screens whether mesh or perforated or solid, such as aluminium, alloy or steel; security and non-security (eg. insect) screens; non-metal screens including plastics, fibre reinforced sheet, cement sheet, woven fibreglass, carbon fibre (eg. Kevlar®)—whether used as access screens, partitions, sheets, fencing, permanent or non-permanent structures; glass panels for use as partitions, eg. in pool fencing or balustrades or facades; internal or external partitions made of timber, plastics, and composites or any of the above described materials.

For the purpose of describing a preferred embodiment of the invention, the detailed description specifically makes reference to frame assemblies applicable for supporting an infill material that is described as a mesh or perforated metal security screen to be fixed to a frame. The infill screen can be flexible, and in the case of a security screen, can be a woven mesh, or substantially rigid, such as with perforated sheets. Such assemblies are suitable for use as security doors, security screens, security windows, general anti-insect (mosquitoes and flies) screens and the like. The initial embodiment described refers to a security door, but is equally applicable for other applications.

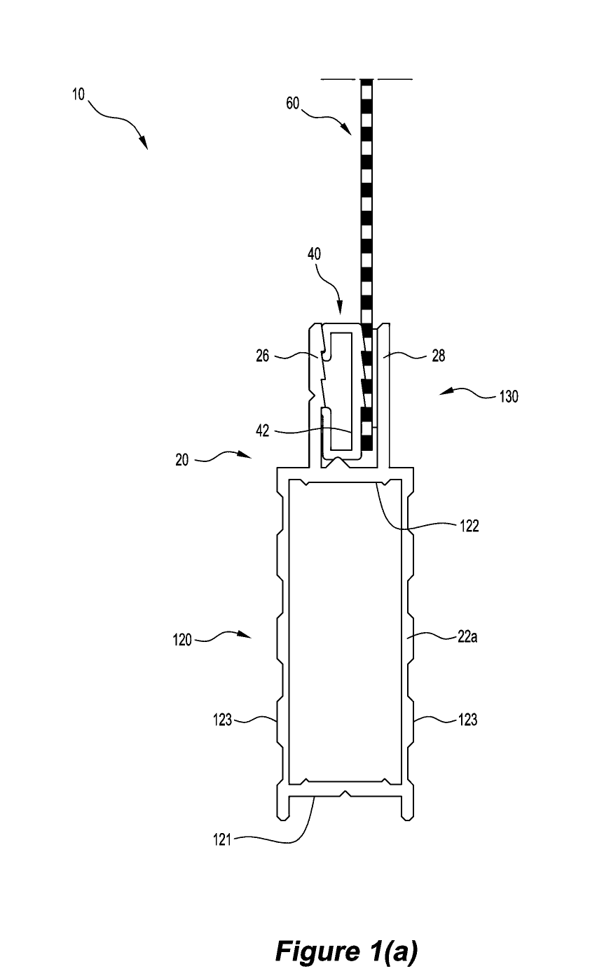

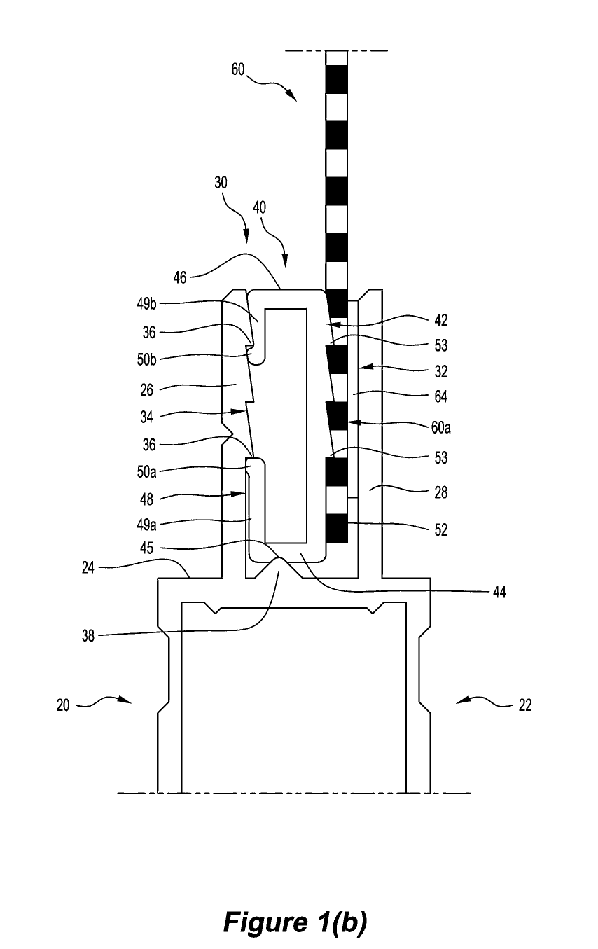

Referring initially to FIGS. 1(a) to 8, a security screen 10 in the form of a security door in accordance with a first preferred embodiment of the present invention comprises a frame assembly 11, specifically in the form of a perimeter frame 20 and a planar sheet infill material, or screen infill, 60. The present invention relates to a new structure, or frame assembly 11, for mounting the infill material 60 to the perimeter frame 20.

The perimeter frame 20 is a rectangular frame comprising separate frame portions 22, where two side frame portions 22a, and top and bottom frame portions 22b define the rectangular frame. FIG. 1 shows a side frame portion 22a, which is a mirror of the other side frame portion 22a and having the same length. Similarly, the top and bottom frame portions 22b are mirrors of each other and are of the same length, being shorter than the side frame portions 22a. The frame portions 22a and 22b have identical cross-section profiles but are arranged in a mirror configuration as required.

The frame portions 22 are mitre (45° angle) cut at their ends 23 for respectively engaging and forming 90° corners of the perimeter frame 20.

Each frame portion 22 forms part of a frame assembly for a security screen 10, where the frame portion has an attachment channel 30 for receiving an edge 60a of the infill material 60.

Referring to FIG. 1(a), each frame portion 22 comprises a beam 120 and an infill material mounting formation 130. The beam 120 is a rectangle hollow section (RHS) comprising an external side 121, internal side 122 and opposing face sides 123.

Referring to FIG. 1(b), each frame portion 22 comprises an internal side surface 24 at the internal side 122. The infill material mounting formation 130 comprises spaced first and second webs 28 and 26 extending generally perpendicularly from the internal side surface 24. The first and second webs 26 and 28 extend longitudinally along the entire internal length of the frame portion 22.

The first and second webs 28 and 26 and the side surface 24 therebetween together define a generally U-shaped attachment channel 30. A first surface 32, internal of the first web 28, provides a smooth flat surface. A second surface 34, internal of the second web 26, comprises in cross-section a serrated surface 34 having a number of spaced teeth formations 36 extending longitudinally along the length of the second web 26. Alternatively, the internal first surface 32 can include small ribbing or protrusions therein.

The side surface 24 between the first and second webs 26 and 28 comprises a male locating protrusion 38 extending longitudinally along the length of the side surface 24.

The security door 10 further comprises a locking insert 40 which is held at one part on the frame portion 22 against an engagement portion on the frame portion so that a second part of the locking insert (that is generally opposite to the first part) bears towards the infill material in the attachment channel 30. The locking insert 40 exhibits resilient properties so that when held by the engagement portion the locking insert applies a securing force to urge the screen in fill against the first surface 32 of the first web 28 of the channel 30.

The engagement portion against which the locking insert 40 is held in the frame may be provided inside the attachment channel 30 or outside of the attachment channel 30, for example as part of a separate channel.

In the embodiments illustrated in FIGS. 1(a) to 8 and 11 to 16, the locking insert 40 is inserted into the attachment channel 30 where the internal second surface 34 acts as the engagement portion that holds a first part 49a, 49b of the locking insert. A second part 42 of the locking insert engages with an edge section 60a of the infill material 60.

Furthermore, a friction interface is provided within the assembly to resist withdrawal of the infill material from the frame portion. The friction interface is provided either between the infill material 60 and the first surface 32 or between the infill material 60 and the locking insert 40. In the form illustrated in the embodiments described herein the friction interface is an adhesive, and generally an adhesive provided on a double-sided adhesive tape. In some embodiments described herein the friction interface is glue.

It is understood that the friction interface may instead be defined by a high friction surface, for example a rubber member.

The locking insert 40 in the first embodiment is an elongated metal hollow generally rectangular section which extends the length of the channel 30 in use. In cross-section, the locking insert 40 comprises a first side 42, an inner end portion 44 and an outer end portion 46 which both extend perpendicularly in the same direction from respective lateral edges the first side 42, and a second side 48 which comprises first and second arms 49a and 49b which respectively extend from respective lateral edges of the inner end portion 44 and the outer end portion 46.

The first and second arms 49a and 49b extend toward each other and each comprises a tooth formation 50a and 50b at their respective ends. The teeth formation 50a and 50b are spaced from each other by a distance corresponding to a space between two teeth formations 36 of the serrated surface 34.

The inner end portion 44 comprises a groove 45 extending longitudinally therealong which is disposed and shaped to receive the locating protrusion 38 of the side surface 24.

Alternatively, the locating protrusion 38 can be disposed in the inner end portion 44 and the groove 45 can be formed in the side surface 24.

The first side 42 comprises an external surface 52 with spaced teeth formations 53 formed therein, the teeth formations 53 extending longitudinally therealong.

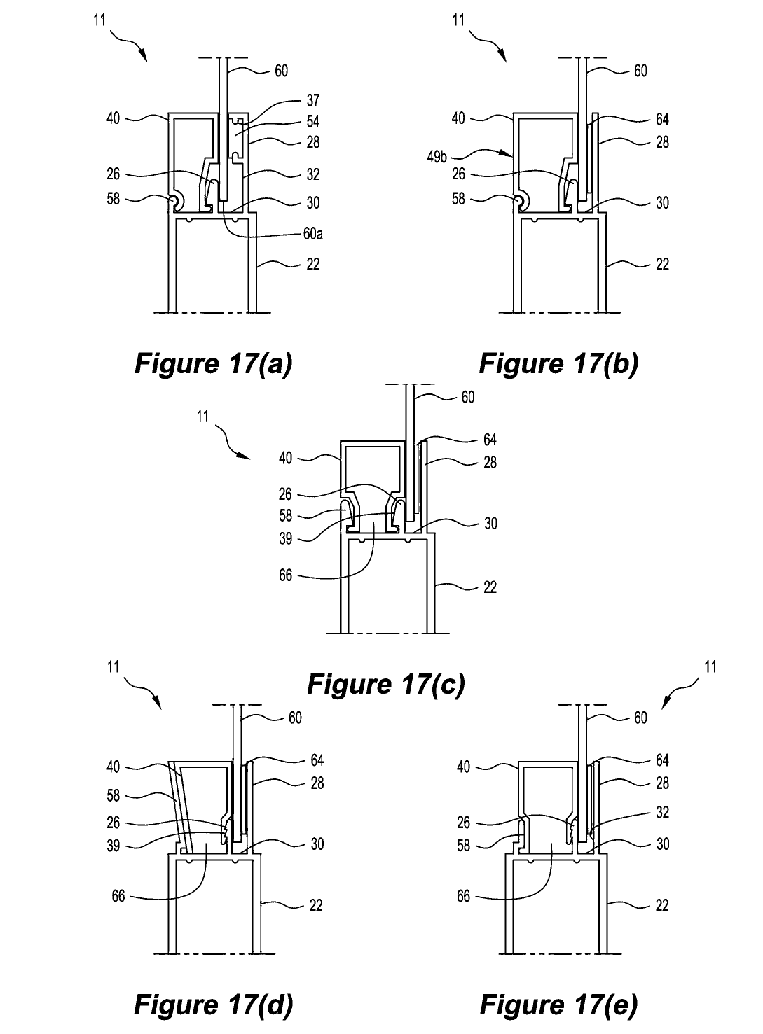

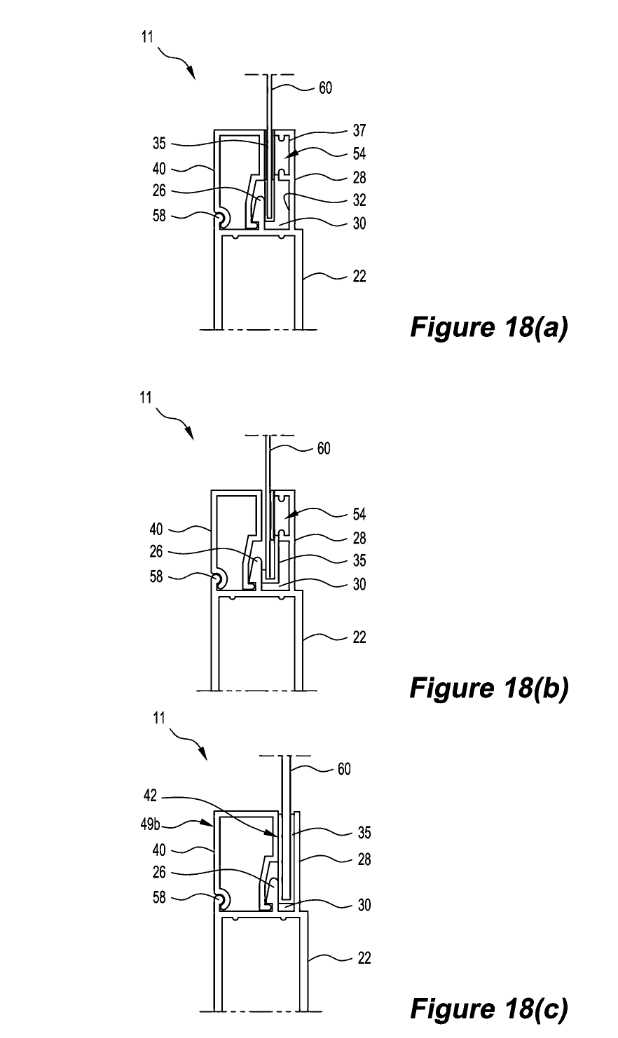

FIGS. 17(a) to 17(e) and FIGS. 18(a) to 18(c) illustrate a various possible designs for the alternative positioning of the locking insert 40 where the locking insert 40 is inserted or mounted in the frame assembly 11 outside of the attachment channel 30.

The frame assemblies 11 in FIGS. 17(a) to 17(e) differ from the frame assemblies 11 of FIGS. 18(a) to 18(c) in that the former frame assemblies are directed to securing an infill material that is made of the same material as the frame portion, for example a perforated aluminium sheet supported in an aluminium frame portion. Where an infill material is used that is of a material dissimilar from the frame portion, for example a woven galvanised steel sheet mounted in an aluminium frame portion, galvanic corrosion can occur. Accordingly, FIGS. 18(a) to 18(c) illustrate frame assemblies 11 where a non-conductive isolator 35 is provided between the dissimilar materials.

Alternatively, the locking insert itself may be made of a non-conductive material to prevent corrosion between dissimilar materials. Such a non-conductive material could be a plastics material, eg. polyvinyl chloride (PVC), a carbon-based material. eg. graphite, or known non-conductive composite materials.

Still further examples of non-conductive materials that could be used for the locking insert include polyamide, nylon, glass filled nylon, high density polystyrene, santoprene, natural or EPDM rubbers and expanded foams. All these materials, and those mentioned above, could be used in locking insert designs which exert an urging force on the mesh to achieve the required hold on the infill and adhesion against the friction interface.

Referring specifically to the frame assembly embodiments of FIGS. 17(a) to 17(e), the frame assemblies 11 each have an attachment channel 30 for receiving an infill material 60 where the attachment channels are defined by a first web 28 and a second web 26. The first surface 32, being the internal surface of first web 28, is shown to be flat in FIGS. 17(b) to 17(e) to provide a suitable surface on which the friction interface (in these embodiments—double sided tape) can adhere.

FIG. 17(a), on the other hand, shows the first surface 32 having an interlocking engagement profile 37 for receiving and retaining a friction member 54 that carries the friction interface, which in this embodiment is double sided adhesive tape that was either applied during the assembly process, or is already provided with adhesive from the manufacturer so that during assembly only a backing tape (not shown) need be removed after insertion of the friction member 54 into the interlocking profile 37. The friction member may be any kind of member capable of supporting a friction interface, and could for example be a rigid polyvinyl chloride (PVC) member.

The second web 26 shown in FIGS. 17(a) to 17(e) is shorter than the first web 28 and its internal surface, second surface 34 guides the edge 60a into channel 30.

The engagement portion 58 for holding locking insert 40 in the embodiments shown in FIGS. 17(a) to 17(e) is a lip (FIGS. 17(a), 17(b)), or a detent (FIG. 17(c)), or a third web (FIGS. 17(d), 17(e)) that defines a second frame channel 66 with the second web 26.

Accordingly, locking insert 40 is mounted between the engagement portion 58 and the second web 26, where a first part of the insert 40 (arms 49a or 49b) is held in the frame portion 22 by the engagement portion 58 and a second part of the insert 40 (first side 42) is held by an external surface 39 of the second web 28.

An advantage of the embodiments illustrated in FIGS. 17(a) to 17(e) where the engagement portion 58 is provided on the outside of the second web 26 to the channel 30 is that the frame portion is able to be assembled to form a perimeter frame 20 of a security door or security window, and the infill material can be inserted in channel 30 of the assembled perimeter before the locking insert is mounted onto the frame portion. In the first embodiment illustrated in FIGS. 1(a) to 8 the frame perimeter is assembled around the infill material. Furthermore, providing the locking insert outside of channel 30 allows easy positioning and adjusting of the infill material before application of the adhesive tape 64, and the infill is free to move and be adjusted until the locking insert is inserted and pressure applied.

External surface 39 may include a locking profile for receiving a complementary profile on the locking insert to act with the engagement portion in securing the locking insert on the frame portion. Alternatively, external surface 39 may comprise a ratchet-type tooth formation that encourages engagement with the external surface 39 one way but discourages withdrawal in the opposite direction. Further still, an adhesive on external surface 39 may be applied to maintain engagement of the locking insert on frame portion 22.

The locking insert 40 in FIGS. 17(a) to 17(e) is shaped to not only exhibit a resilience in maintaining the locking insert in engagement with the frame portion 22 but to also exert a pressure, or force, against the infill material 60. The locking insert 40 is shaped to extend over the second web 28 and suitably apply a securing force against infill 60. The force against infill 60 urges the infill against the first surface 32 of first web 26, which in effect clamps or securely holds the infill material between the locking insert 40 and first web 26 thereby securing the infill in the frame assembly.

FIG. 17(c) illustrates a variation of the locking insert 40 whereby the locking insert has an upper part and a lower part, the lower part functioning to retain the locking insert in second channel 66 and the upper part functioning to apply pressure against the infill material 60.

Each of FIGS. 17(a) to 17(e) illustrate locking inserts having different cross sectional profiles that are shaped to function to both exhibit resilience to retain the locking profile on the frame portion and to expose a first side 42 (first part) of the insert 40 to the infill material which applies a force towards the infill material, and specifically directly against the infill material (if there are no intermediate parts provided between the infill material and first side 42).

FIG. 17(d) illustrates the locking insert having a tapered arm 49a that bears against a correspondingly tapered engagement portion 58 in the form of a third web. An advantage with this design is that the contact between the locking insert and the infill material only occurs at the final point of insertion, which reduces the probability of scuffing or damage to the surface of the infill material. Additionally, if the adhesive tape is applied on the locking insert or the locking insert side of the infill material, the adhesive will not come into complete contact until the locking insert is fully inserted at the last point of insertion. This is useful in reducing the risk of the adhesive inadvertently coming into contact with the incorrect part which would cause damage to the adhesive tape and/or the locking insert.

It is noted that the orientation of the locking insert 40 of these embodiments is different from that of FIGS. 1(a) to 8 in that the resilience between the first arm 49a relative to the second arm 49b is used to hold the locking insert under a bias/compression in FIGS. 17(a) to 17(e), whereas in FIGS. 1(a) to 8 it is the resilience between arms 49a, 49b and first side 40 that direct the pressing force toward the infill material.

Where adhesive tape is used as the friction interface to reduce the chance of withdrawal of the infill material from the channel 30, the adhesive tape 64 can be applied to either between the first web 26 and the infill material 60, or between the locking insert 40 and the infill material 60. It is understood that while it is preferred that the adhesive be in direct contact with the infill material and the locking insert or first web, the adhesive could instead be applied to an intermediate part provide in between, for example a spacer could be provided between the adhesive tape and the first web.

FIGS. 18(a) to 18(c) show frame assemblies 11 that are similar to the frame assemblies of FIGS. 17(a) and 17(b) but that are, as discussed above, additionally provided with a non-conductive isolator 35 to separate the infill material 60, which is made of one material, from the frame portion 22 and/or locking insert 40, which are made of a different material.

FIG. 18(a) illustrates the isolator 35 as being an extension of the friction member 54 that in cross section is extended to wrap around the edge 60a of the infill material 60. A second adhesive tape 64 is applied to the isolator 35 (on the wrapped around part of the friction member) between the isolator and the infill material. This provides increased adhesion and assists in holding the isolator in place. The isolator may be sufficiently long to not only ensure there is no contact between the infill material and the frame portion, but also ensures there is no contact between the locking insert and the infill material if they too are of dissimilar materials.

In the embodiment illustrated in FIG. 18(b), the isolator 35 is also an extension of the friction member 54 seen in FIG. 18(a) but only extends under the infill material edge 60a and does not isolate contact between the locking insert and the infill material. This embodiment is useful where the locking insert is made of the same material as the infill material, eg. aluminium, or it is made of a non-conductive material, eg. PVC.

FIG. 18(c) illustrates another version of the isolator 35, which in this example is a length of adhesive tape 64 that wraps all the way around the edge to separate the infill material from contact with the frame portion 22 and the locking insert 40. Advantageously, this embodiment uses fewer parts than that of FIGS. 18(a) and 18(b) and with adhesive applied all the way around the edge 60a, has an increased resistance to withdrawal of the infill material. This is particularly true for infill materials that are a woven or mesh material which, given their non-flat cross section, find it more difficult to achieve a sufficient contact area for adhesion.

The infill material 60 in the embodiment is a perforated rectangular aluminium sheet 0.5 to 4 mm thick. Other infill material can also be used such as, solid, windowed, perforated or otherwise apertured stainless steel sheets, flexible woven screen mesh, a corrosion resistant coated steel sheet such as galvanised steel sheet or a steel sheet with a zinc/aluminium alloy coating such as that sold under the trade mark ZINCALUME.

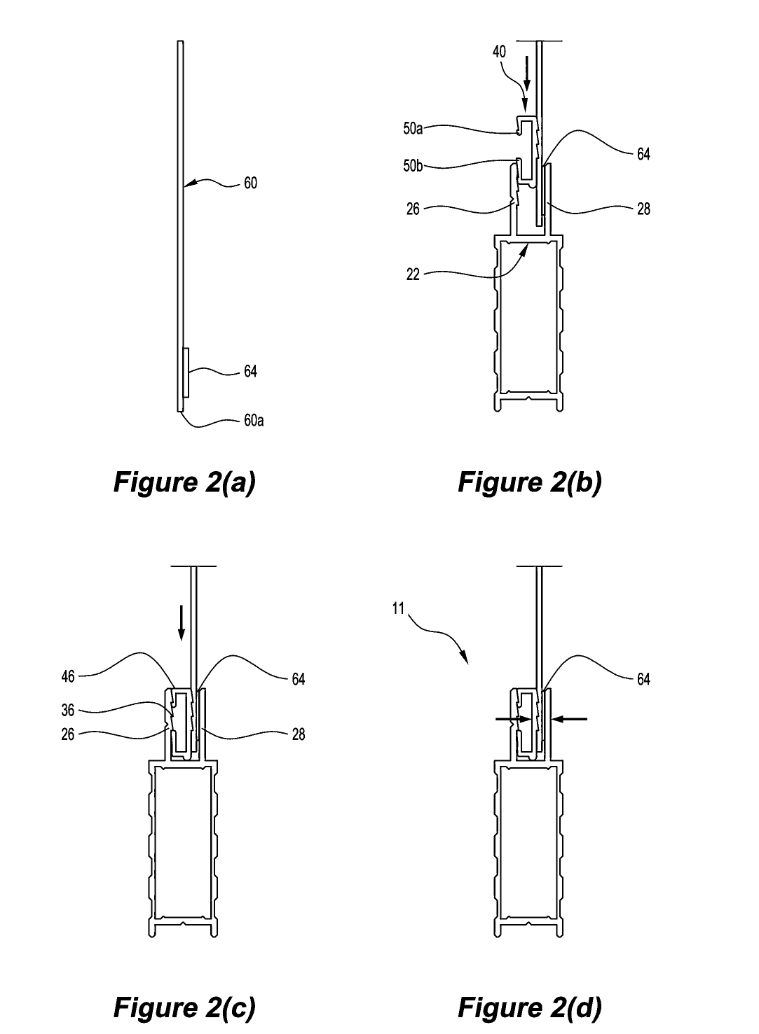

Assembly of the security door 10 will is described with reference to FIGS. 2(a) to 8.

FIGS. 2(a) to 2(d) illustrate schematically the steps in assembling the components of the first embodiment of a frame assembly together with an infill material. As illustrated in FIG. 2(a), the friction interface in the form of adhesive tape 64 is first applied to one side of the edge 60a of the infill material 60. Where the friction interface is not an adhesive tape, eg. a glue or a friction member 54, the friction interface will be applied to the frame portion 22 either before or after insertion of the infill material.

Next, as illustrated in FIG. 2 (b) the infill material with adhesive tape applied is inserted into position with the tape facing the first web 28. The locking insert 40 is then inserted into the space between the infill material 60 and the second web 26. Due to the resilience of the locking insert, the insert 40 will deflect making insertion sufficiently easy to be carried out by manually pressing down onto the upper facing planar surface, which acts as a pressure surface against which a pressure can be applied manually or by a tool in order to insert insert 40. In the embodiment shown the pressure surface is the outer end portion 46. During insertion teeth formation 50a and 50b on the locking insert pass over teeth formations 36 of the serrated surface 34 of the second web 26.

FIG. 2(c) illustrates the locking insert locked in position in the channel 30 by resistance from the teeth formations 36 resisting withdrawal of the locking insert.

Once assembled, and as shown in FIG. 2(d), the locking insert applies a force against infill material 60 to urge it against first web 28 and the adhesive tape inbetween. In effect, the locking insert clamps the infill material in the frame portion.

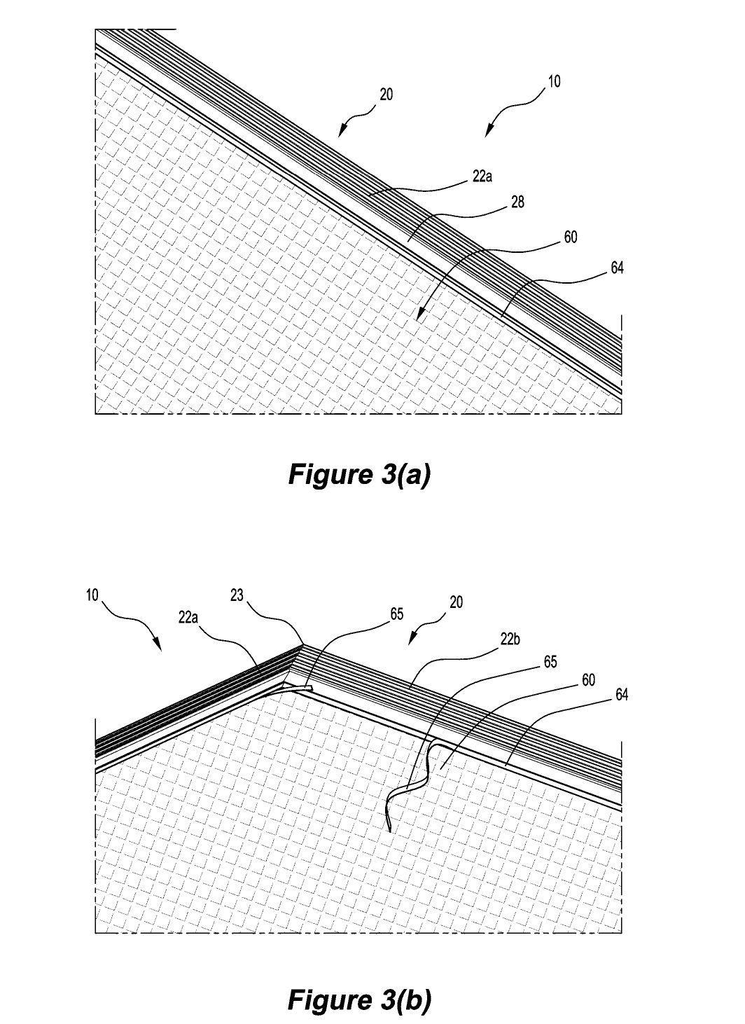

The following is a description of the method to assemble a screen infill material in a frame assembly to form a security screen door as shown in FIGS. 3(a) to 8.

Referring to FIG. 3(a), each edge section 60a of the infill material 60 is initially cleaned with a cleaner solution. A first adhesive side of a double-sided adhesive tape 64 is then applied along each edge section 60a. Each frame portion 22 is oriented such that the second web 28 will face the adhesive tape 64 applied to the infill material 60. In the embodiment, the adhesive tape 64 used is 3M VHB™ structural two sided tape, which is at least partly compressible.

Referring to FIG. 3(b), lead portions of the remaining tape backing 65 of the adhesive tape 64 are then initially removed prior to inserting the edge sections 60a of the infill material 60 into the channels 30 of the respective frame portions 22. This step is performed for all four frame portions 22. The ends 23 of the frame portions 22 respectively engage and form the corners of the perimeter frame 20.

Referring to FIG. 4, the remaining tape backing 65 of the adhesive tape 64 are then completely removed whilst the edge sections 60a are in the channels 30 of the frame portions 22.

Referring to FIG. 5, the infill material 60 and the frame portions 22 are then inverted, and the locking insert 40 for a frame portion 22 is placed in its insertion position at a side of the infill material 60 opposite to that having the adhesive tape 64. Referring to FIGS. 1(b), 5 and 6, the locking insert 40 is positioned such that inner end portion 44 faces the channel 30 and the first side 42 engages the infill material 60.

Referring to FIGS. 6 to 8, the locking insert 40 is pushed into the channel 30 until substantially the entire locking insert 40 is disposed within the channel 30. FIG. 8 shows left side sections of the locking insert 40 fully inserted and right side sections thereof requiring further insertion.

Referring to FIG. 1(b), when fully inserted, the outer end portion 46 of the locking insert 40 is substantially aligned with the ends of the first and second webs 28 and 26. The groove 45 of the inner end portion 44 receives the locating protrusion 38 of the side surface 24. The teeth formation 50a and 50b engage two respective teeth formations 36 of the serrated surface 34. The teeth formations 53 of the first side 42 engage the infill material 60.

The locking insert 40 is dimensioned for insertion into the channel 30 and for urging the infill material 60 towards the second web 26, thus compressing the adhesive tape 64 therebetween. The locking insert 40 provides a pressure of at least 10 psi, and preferably at least 15 psi (and about between 15-20 psi) against the infill material 60 to allow the adhesive tape 64 to form a strong bond between the edge section 60a and the frame portion 22. The first and second arms 49a and 49b can bend slightly during the insertion step to assist in the insertion of the locking insert 40 into the channel 30.

Once inserted, the teeth formations 53 engaging the infill material 60 with the adhesive tape 64 prevent the removal of the edge section 60a from the channel 30. The teeth formation 50a and 50b engaging the teeth formations 36 of the serrated surface 34 provides a one-way insertion of the locking insert 40 into the channel 30, and they lock the locking insert 40 in the frame portion 22.

A respective locking insert 40 is inserted for each frame portion 22. If desired, an additional attachment means is provided between the adjacent frame portions 22.

The force required to insert the locking insert into the frame portion is less than expected for a security screen whilst having the strength to withstand significant impact. This is due to the resilient nature of the locking insert, which may be a result of the physical structure of the insert, or a result of its material, or a combination of both. This thereby allows an easier and faster assembly of the locking insert compared with the assembly of known security screens. In using the present frame assembly there are no great forces required to be overcome in wedging the locking insert into the frame portion. Rather, the locking insert can be inserted manually without tools and by hand, or alternatively with a simple mallet and block in order that the locking insert, once inserted, applies a sufficiently strong force to hold the infill against the friction interface (usually tape) so that there is sufficient friction/adhesion between the infill and friction interface to retain the infill in the frame, and to prevent lateral movement of the infill as a result of a force striking the infill.

As discussed above, to achieve a sufficiently strong force to hold the infill against the friction interface will require the locking insert, in a preferred embodiment, to apply a minimum pressure of at least 10 psi and preferably at least 15 psi against the edge portion of the infill. From the opposite perspective, the locking insert will apply a maximum pressure of less than 75 psi against the infill material, and preferably less than 50 psi.

To illustrate, and in general terms quantify, the force required to insert the locking insert into the frame assembly a test was devised and results are shown in the following Example.

### Example 1

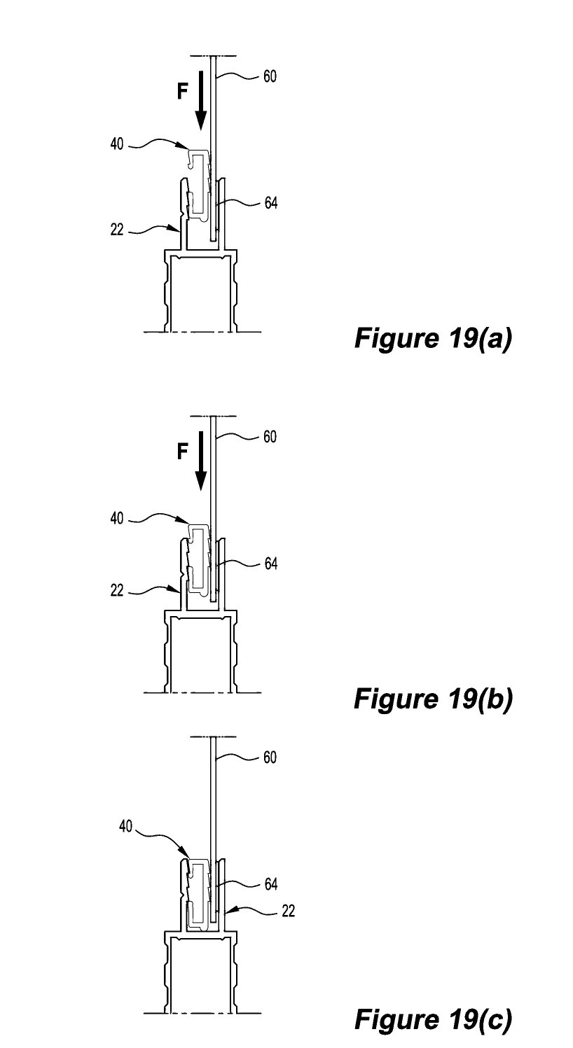

A test rig was set up using locking insert samples having a length of 300 mm and the force required to insert the locking insert into a corresponding frame portion was measured. Force measurements were taken at three points in the insertion process, which are the points at which a maximum force is required to overcome the ‘teeth’ or pawls in the frame portion. These three points are sequentially illustrated in FIGS. 19(a), 19(b) and 19(c). Namely, the force measured is the peak load required to overcome the resistance between the frame portion and locking insert in order to reach the positions shown in FIGS. 19(a), 19(b) and 19(c).

Table 1 demonstrates the peak forces recorded at each position over five test cases.

TABLE 1

| | Position 1 | Position 2 | Position 3 |
|---|---|---|---|
| | (FIG. 19(a)) | (FIG. 19(b)) | (FIG. 19(c)) |
| | F_{MAX} (N) | F_{MAX} (N) | F_{MAX} (N) |
| Sample 1 | 17 | 36 | 68 |
| Sample 2 | 81 | 160 | 281 |
| Sample 3 | 68 | 140 | 244 |
| Sample 4 | 66 | 132 | 256 |
| Sample 5 | No Reading | 200 | 237 |

The tests were carried out as follows:
Sample 1—locking insert forced into frame against 1.2 mm perforated aluminium infill sheet, no tape;
Sample 2—locking insert forced into frame against 1.2 mm perforated aluminium infill sheet, 0.80 mm double sided tape with protective backing left on;
Sample 3—locking insert forced into frame against 1.2 mm perforated aluminium infill sheet, 0.80 mm double sided tape with protective backing removed;
Sample 4—locking insert forced into frame against 1.2 mm perforated aluminium infill sheet, 1.60 mm double sided tape with protective backing left on;
Sample 5—locking insert forced into frame against 1.2 mm perforated aluminium infill sheet, 1.60 mm double sided tape with protective backing removed.

A ‘No Reading’ was recorded when there was no discernable arrival at the position, and the locking insert continued to the next position.

The results were then extrapolated to a value shown in Newtons per lineal metre using the following equation:

$$( {F}_{MAX} ) \times ( \frac{1000}{300} )$$

The extrapolated results are shown in Table 2.

TABLE 2

| | Extrapolated Forces to N/lineal m | | |
|---|---|---|---|
| | Position 1 | Position 2 | Position 3 |
| | (FIG. 19(a)) | (FIG. 19(b)) | (FIG. 19(c)) |
| | F_{MAX} (N/lineal m) | F_{MAX} (N/lineal m) | F_{MAX} (N/lineal m) |
| Sample 1 | 57 | 120 | 227 |
| Sample 2 | 270 | 533 | 937 |
| Sample 3 | 227 | 467 | 813 |
| Sample 4 | 220 | 440 | 853 |
| Sample 5 | No Reading | 667 | 790 |

The above results show that the locking insert could be comfortably inserted into the frame portion using only around 65-240 N per 300 mm of maximum force (or 225-800 N per lineal metre). It is expected that a suitable insertion force range could feasibly span from 50 to 250 N per 300 mm, or 150 to 1000 N per lineal metre.

Other tests showed that the maximum force required to insert the locking insert into the frame portion could be as high as 750N per 300 mm (2500N per lineal metre), that is to say that the insertion force would be no greater than 750N/300 mm or 2500N/lineal metre.

### Infill Screen Retention

The maximum force required to insert the locking insert, which is sufficiently low to enable manual assembly or at least easy assembly, is coupled with the locking insert's ability to apply a sufficiently high retaining force, or pressure, against the infill screen to be able to effectively retain the infill material, for example, to the standard required of security screens.

In terms of retaining a security screen, there are a variety of tests set by Standards organisations worldwide that determine the effectiveness of retention. It is understood that the frame assembly and locking insert described herein, while providing the ability for easy insertion of the locking insert, will effectively meet the required standards for retaining an infill material as a security screen, or as a balustrade, or as a partition, or as whatever the desired purpose of the infill material is.

By way of example, the Australian Standard AS5039 prescribes tests a screen must pass in order to be deemed a security screen. One test is the dynamic impact test which involves subjecting an infill screen to five separate impacts delivered at 100 Joules at a position on the screen that is 250 mm from a vertical edge of the screen (horizontal distance), and that is at a vertical distance from the lesser of either 600 mm from the bottom of the screen, or the centre of the screen. If the screen infill remains within the frame such that it has not separated from the surrounding frame and that there is no breach of the infill (eg. infill tearing), it has passed the requirement for suitably retaining an infill in a frame for a security screen.

It is understood that other tests and standards may apply depending on the purpose of the frame assembly and the infill material, and while the above test may be suitable for a security screen, it may not be for other purposes, for example, balustrades, fencing, partition structures, or any other purpose similar to those described herein and using materials both described herein or known alternatives of the materials described herein.

The preferred embodiment reduces manufacturing costs as, in contrast to current systems which employ mechanical fasteners such as rivets and cover trims, the present retention system has less components and will take less time to assemble. This results in cost savings for both the manufacturer and the consumer.

The present retention system allows the use of other types of infill material sheets such as stainless steel mesh, flexible screen mesh, or a coated steel sheet such as with a zinc/aluminium alloy coating that is sold under the trade mark ZINCALUME, with some minor adjustments to the locking insert 40 if required.

Whilst preferred embodiments of the present invention have been described, it will be apparent to skilled persons that modifications can be made to the embodiments described. For example, although the present example describes a security door, the present retention system can also be used for other applications such as insect screens, windows, and the like.

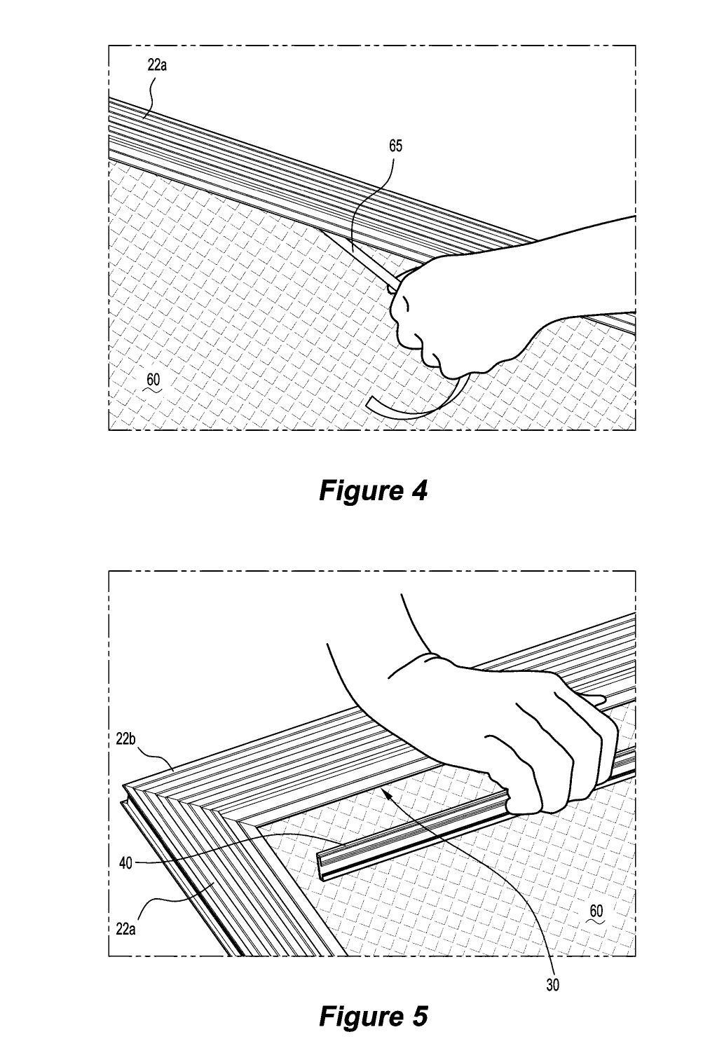

FIG. 9 shows an alternative embodiment of the frame portions 22 and the locking insert 40. In this embodiment, the frame portion 22 comprises only the second web 26 extending from the internal side surface 24. The second web 26 comprises a first portion 26a extending perpendicularly from the side surface 24, a second portion 26b extending perpendicularly from an edge of the first portion 26a, and a third portion 26c extending perpendicularly from an edge of the second portion 26b. The side surface 24 and the first and second portions 26a and 26b define therebetween a connection channel 31. Opposing faces of the side surface 24 and the second portion 26b comprise serrated connection formations 33. A surface 32 of the third portion 26c provides a smooth flat attachment surface.

The locking insert 40 in this embodiment comprises a first side 42 having a connection means 43, being spaced parallel webs 51 extending perpendicularly from the first side 42. The webs 51 comprise external serrated formations 55 for engaging and locking with the connection formations 33 in the connection channel 31. A distal section 59 of the first side 42 further comprises spaced engagement protrusions 57. The purpose of the locking insert 40 is to support the adhesive tape 64 during the setting stage and to act as a finishing trim. The locking insert 40 when installed into the frame portion 22 applies pressure that is required for the adhesive tape 64 to bond effectively with the mesh 60 and the internal flat surface 32 of the third portion 26c.

In assembly, the adhesive tape 64 is applied to the edge section 60a of the infill material 60, which is used to attach the edge section 60a to the third portion 26c of the second web 26. The connection means 43 of the locking insert 40 is then inserted into the connection channel 31. The distal section 59 of the first side 42 and the third portion 26c of the second web 26 form the U-shaped attachment channel 30 which retains the infill material 60.

In an alternative embodiment, the connection channel 31 can be formed in a face side 123 of the beam 120.

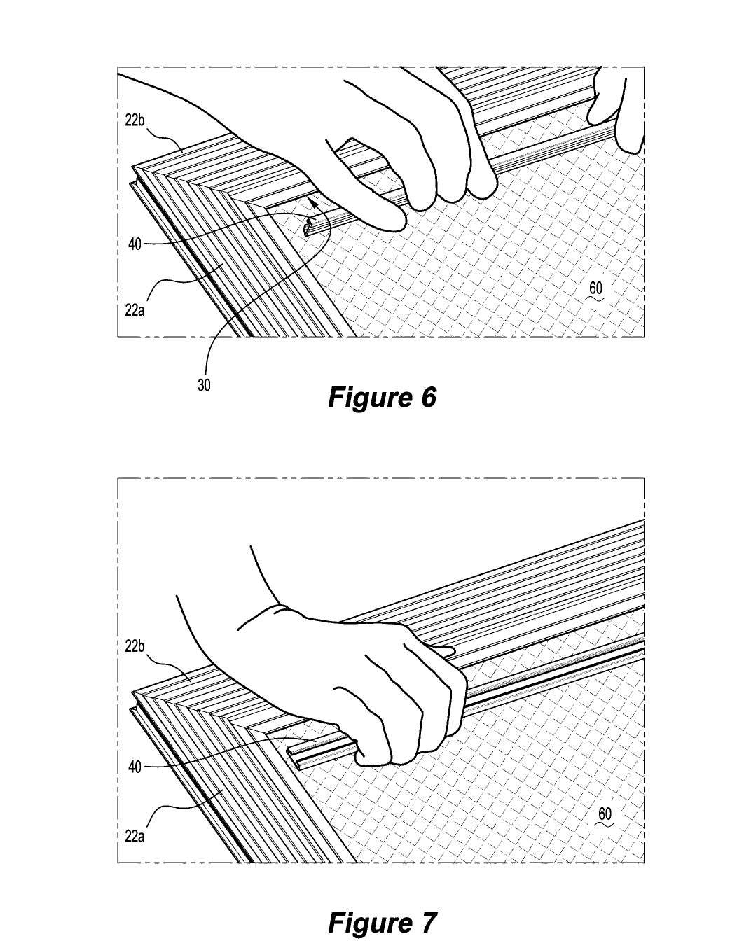

FIG. 10 shows another alternative embodiment of the frame portion 22. In this embodiment, the first and second webs 26 and 26 and the side surface 24 together define first and second mounting glue receiving chambers 91 and 92.

In cross-section, the first web 28 comprises a distal end tab 95 extending towards the second web 26. The second web 26 comprises a first web 97 disposed closer to the side surface 24 than the end tab 95, and a distal second web 99 is disposed further away from the side surface 24 than the end tab 95.

The first web 97, second web 99 and end tab 95 are disposed and spaced away from each other to provide an attachment channel 30 therebetween for receiving the edge section 60a of the infill material 60. The attachment channel 30 thus provides three spaced points of contact to the edge section 60a.

The first glue receiving chamber 91 is defined between the first web 97, second web 99 and end tab 95. The second glue receiving chamber 92 is defined between first web 97, end tab 95 and the side surface 24.

In assembly, attachment glue 110 is disposed in the first glue receiving chamber 91. The edge section 60a is then inserted into the attachment channel 30, which moves at least some of the glue 110 towards the second glue receiving chamber 92. The first web 97 includes an angled surface 101 that leads into the second receiving chamber 92. The glue 110 dries and expands further into the second receiving chamber 92 and retains the edge section 60a to the frame member 22. The locking insert 40 and adhesive tape 64 are not required in this embodiment.

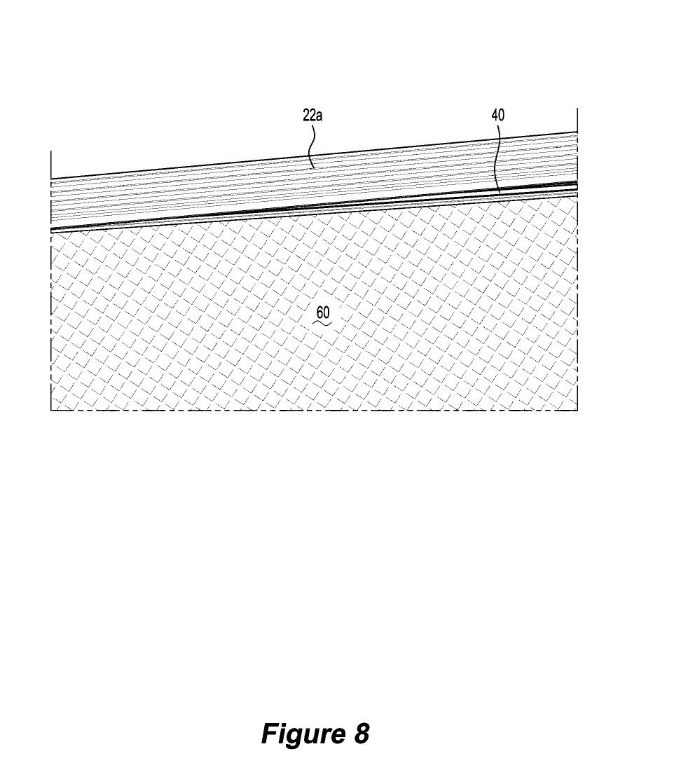

FIG. 11 shows an assembly is similar to that shown in FIG. 1 but adapted for use as a window security screen. In this embodiment, the first and second webs 28 and 26 are respectively aligned with the face sides 123 of the beam 120. This positions the infill material 60 (the mesh) substantially flush with the outer face of the frame 20.

Aligned pin apertures 140 are formed at spaced locations along the frame 140. Each set comprises apertures in the external side 121 and internal side 122 of the beam 120, and the inner end portion 44 and outer end portion 46 of the locking insert 40. A locking pin 150 can then be inserted through the aligned pin apertures 140 from the outer and portion 46 to extend outwardly from the external side 121 of the beam 120. As shown, the locking pin 150 is movable from a retracted position at which it is retracted from the external side 121, and a locking/extended position at which it extends outwardly from the external side 121.

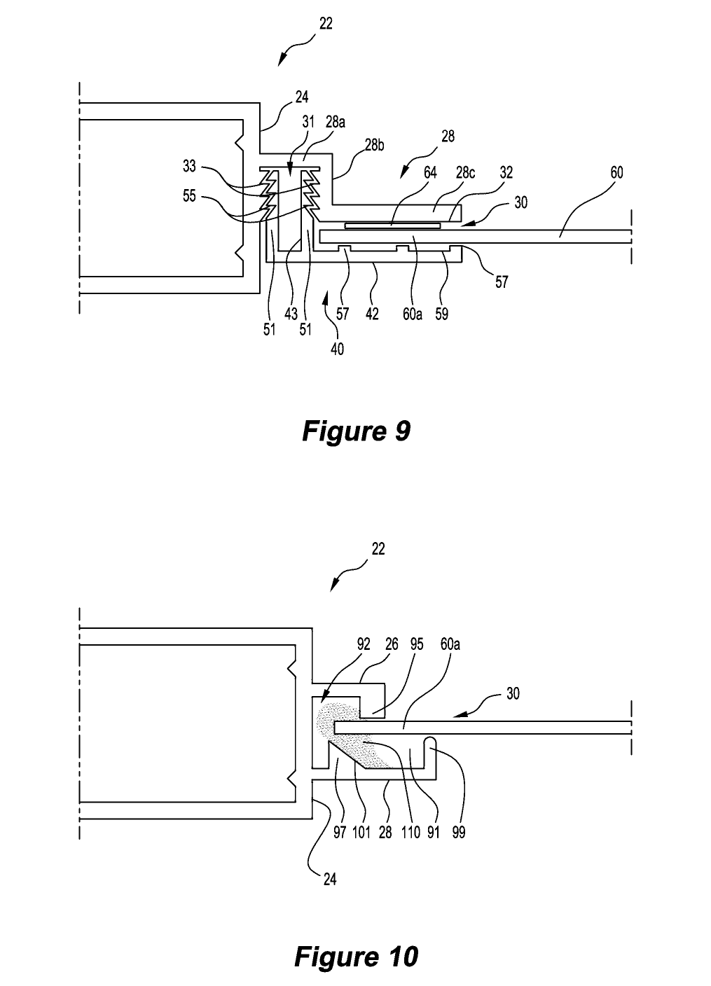

FIG. 12(a) schematically shows the installation of a window screen 170 to a window frame 180. The window screen 170 is made according to the embodiment shown in FIG. 11. One side edge of the window screen 170 is attached by hinges 172 to one side of the window frame 180. A second side edge of the window screen 170 is selectively lockable to the other side of the window frame 180 via spaced locking pins 150. The window frame 180 includes corresponding receiving apertures formed therein for receiving the end portions of the locking pins 150. In this manner, the window screen 170 is hingedly attached to the window frame 180 and can be locked thereto via the pins 150.

FIG. 12(b) shows a modification where the hinges 172 are replaced by further locking pins 150. This allows the window screen 170 to be fully removable.

This embodiment of the present invention provides a secure window screen which can replace the typical flimsy and unsecure flexible insect screens currently used in buildings and houses. The window screen 170 can be locked to the window frame from the inside of the residence and cannot be tampered with from the outside. The window screen is removable by the occupants from the inside if required, for example in the event of a fire emergency.

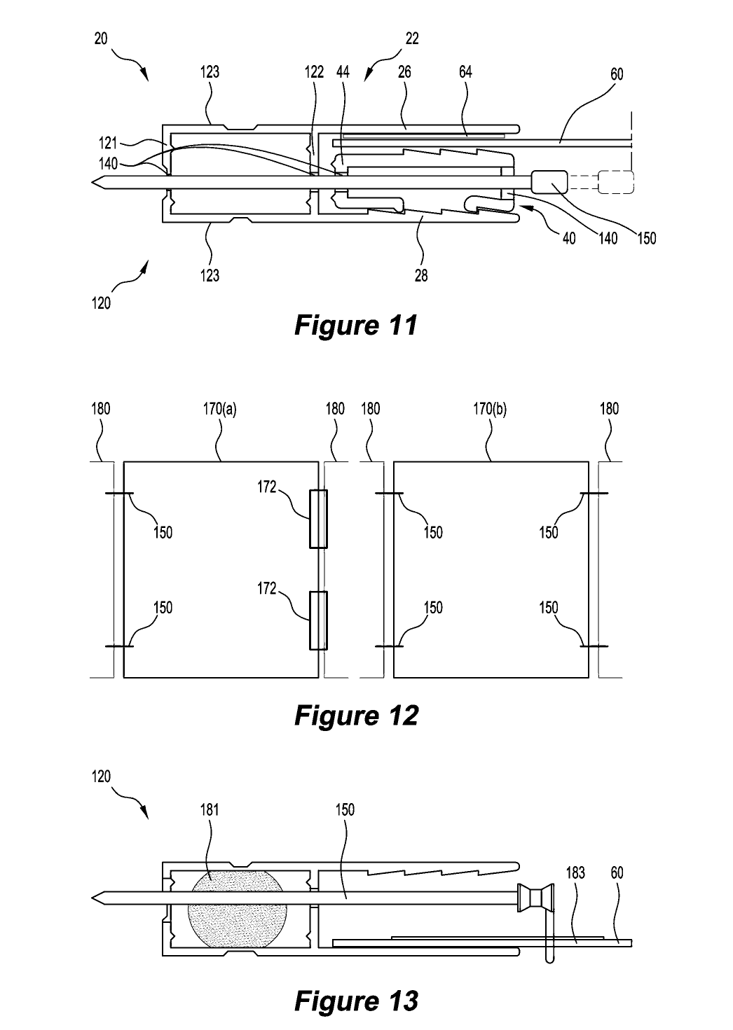

FIGS. 13 to 17 show modified embodiments of the assembly of FIG. 11, to provide for biasing of the locking pin 150 towards its locking position, resisting means for resisting removal of the locking pins 150, and/or locking the locking pin 150 in its locked position.

FIG. 13 shows the addition of foam 181 within the beam 120 through which the pin 150 is inserted to provide for resistance against movement of the pin 150. An anti-tamper plate 183 can also be used, the pin 150 being inserted through the plate 183, with a broad surface of the plate 183 engaging the infill material 60. This again provides resistance to removal of the pin 150.

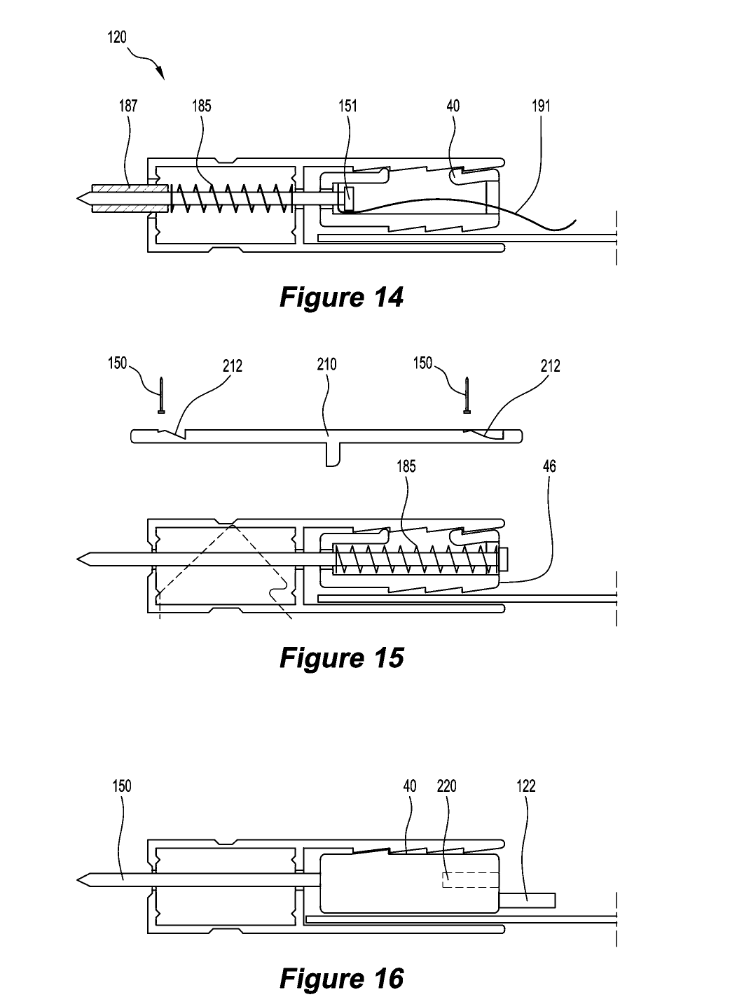

FIG. 14 shows the use of a biasing spring 185 within the beam 120, the spring 185 engaging a sleeve 187 at the external end of the pin 150, to bias the pin 150 towards its extended/locking position. The pin 150 is shorter with the head 151 thereof disposed within the locking insert 40. A strap 191 is attached to the pin 150 for pulling the pin 150 as needed against the force of the spring 185.

FIG. 15 shows an embodiment where the pins 150 are biased towards its retracted position by a spring 185. A movable bar 210 having angled surfaces 212 is disposed across the face of the outer end portion 46 of the locking insert 40, the bar being slidable to engage the spaced pins 150 and move them between an engagement and a disengagement position.

FIG. 16 shows a custom cartridge 220 adapted to provide push button 222 insertion and removal of the pins 150. The cartridge 220 can be formed as part of the locking insert 40. The above embodiments allowable for mounting of the window screen to the window frame. The window screen frame member is 22 are typically narrow (11 mm) but the present invention still allows for their secure attachment to the window frame.

The invention is associated with Australian provisional applications 2013904761 and 2014901763. The content of those applications is incorporated herein by this reference.

1. A frame assembly for retaining a screen, comprising:
a frame portion with an attachment channel for receiving an edge of a screen infill, the attachment channel having a first surface and the frame portion including an engagement portion against which a first part of a locking insert is held, wherein the locking insert has a second part for bearing towards a screen infill inserted in the attachment channel, the locking insert being resilient so as to deflect upon insertion into the attachment channel and so that when the locking insert is positioned with the first part held by the engagement portion the second part applies a force to urge the screen infill against the first surface; and
a friction interface provided either between the screen infill and the first surface and/or between the screen infill and the locking insert.

2. The frame assembly claimed in claim 1, wherein the attachment channel has a second surface spaced from the first surface and the second surface defines the engagement portion against which the locking insert is held.

3. The frame assembly claimed in claim 1, wherein the attachment channel is defined by the first surface and a second surface spaced from the first surface, and the engagement portion against which the locking insert is held is provided outside the attachment channel.

4. The frame assembly claimed in claim 2, wherein the second surface comprises a locking profile for engaging the locking insert.

5. The frame assembly claimed in claim 3, wherein the engagement portion comprises a locking profile for engaging the locking insert.

6. The frame assembly claimed in claim 4, wherein the locking insert comprises an engagement formation for engaging the locking profile.

7. The frame assembly claimed in claim 5, wherein the locking insert comprises an engagement formation for engaging the locking profile.

8. The frame assembly claimed in claim 1, wherein the friction interface is a member having a high friction surface.

9. The frame assembly claimed in claim 1, wherein the friction interface is carried on a friction member adapted to be held against the screen infill by an interlocking engagement with the first face.

10. (canceled)

11. A locking insert for inserting into a frame portion of a frame assembly for retaining an infill material, the locking insert having a first part for engaging against an engagement portion of the frame portion, and a second part for bearing towards an infill material, wherein the locking insert is resilient so as to deflect upon insertion into the frame portion and so when the locking insert is positioned with the first part held by the engagement portion, the second part applies a retaining force to secure the infill material in the frame portion.

12. The locking insert claimed in claim 11, defined by a maximum insertion force of less than 2500 Newtons per lineal metre to insert the locking insert into engagement with the frame portion.

13. The locking insert claimed in claim 11, defined by a maximum insertion force of between 150 to 2500 Newtons per lineal metre to insert the locking insert into engagement with the frame portion.

14. The locking insert claimed in claim 11, wherein the locking insert is shaped to exhibit resilience and to deflect upon insertion.

15. (canceled)

16. The locking insert claimed in claim 11, wherein the locking insert is elongate and shaped in cross-section to substantially comprise a “C” shape having an end portion and arms extending substantially perpendicularly from the end portion.

17. The locking insert claimed in claim 11, wherein one or more of the arms comprise an engagement formation for engaging the engagement portion of the frame portion.

18. The locking insert claimed in claim 11, comprising a pressure surface against which pressure can be applied during assembly to insert the locking insert into a frame portion.

19. A method of assembling a screen infill in a frame assembly, including:
applying a friction interface on one side of an edge of a screen infill;
inserting the edge of the screen infill into an attachment channel in a frame portion of the frame assembly;
inserting a locking insert into the frame portion and positioning the locking insert between the screen infill edge and an engagement portion of the frame portion, wherein the locking insert is resilient so as to deflect upon insertion into the attachment channel and so that the locking insert applies a securing force toward the screen thereby clamping the screen and friction interface between the locking insert and a surface of the attachment channel.

20. The method claimed in claim 19 including applying an adhesive tape to one or both sides of the screen infill edge.

21. A security screen comprising:
a frame portion with an attachment channel for receiving an edge of a screen infill, the attachment channel having a first surface and the frame portion including an engagement portion against which a first part of a locking insert is held, wherein the locking insert has a second part for bearing towards a screen infill inserted in the attachment channel, the locking insert being resilient so as to deflect upon insertion into the attachment channel and so that when the locking insert is positioned with the first part held by the engagement portion the second part applies a force to urge the screen infill against the first surface; and
a friction interface provided either between the screen infill and the first surface and/or between the screen infill and the locking insert; and
a screen infill secured in the frame assembly.

22. The security screen claimed in claim 21, wherein the screen infill is a perforated or woven mesh screen.

23. (canceled)
